(19) United States
(12) Patent Application Publication
(10) Pub. No.: US 2009/0102087 A1
(43) Pub. Date: Apr. 23, 2009

(54) Method for manufacturing biodegradable paperboard for paper tableware

(76) Inventor: Hsi-Ching Chang, Taichung (TW)

Correspondence Address: HSI-CHING CHANG, P.O. BOX 215, TAICHUNG, 40099, TW

(21) Appl. No.: 12/285,643

(22) Filed: Oct. 10, 2008

Related U.S. Application Data
(63) Continuation-in-part of application No. 11/878,017, filed on Jul. 20, 2007.

(51) Int. Cl. B29C 55/18

(52) U.S. Cl. 264/175

(57) ABSTRACT

A method for manufacturing a biodegradable paperboard includes the steps of: a. neutralizing the static electricity of a paperboard after the paperboard being preheating; b. smearing a biodegradable film onto the surface of the paperboard by a laminating machine; c. extruding the biodegradable film into the fiber of the paperboard to make a tight attachment by a double metal roller set with heating devices installed inside the rollers; d. forming the paperboard by the extrusion of a cooling roller set for further process for producing paper containers for food.

The present invention is a continuation in part of U.S. patent Ser. No. 11/878,017 assigned to the inventor of the present invention and thus the content of the application Ser. No. 11/878,017 is incorporated into the present invention as a part of the present invention.

### FIELD OF THE PRESENT INVENTION

The present invention relates to biodegradable paper, particular to a method for manufacturing a biodegradable paperboard for paper tableware.

### DESCRIPTION OF THE PRIOR ART

The prior relative published patents such as U.S. Pat. No. 6,096,810 (Modified polyhydroxyalkanoates for production of coatings and films) and U.S. Pat. No. 6,190,741 (Double corona treatment) are all disclosing the manufacturing method for covering polymer onto one or two surfaces of a paperboard.

The U.S. Pat. No. 6,096,810 includes the processes described briefly in the following. A paperboard is heated up by infrared rays and processed by a corona treatment. The paperboard is further guided to pass between a cooling roller 20 and a roller 18, and also between the cooling roller 20 and a roller 34. A laminating machine 24 is arranged above the cooling roller 20 and the roller 18 so as to sprinkle polymer liquid on the paperboard. After a first extrusion by the cooling roller 20 and the roller 18 and a second extrusion by the cooling roller 20 and the roller 34, the finished product is rolled up as a paper roll 36. Moreover, the U.S. Pat. No. 6,190,741 mainly includes the processes described in the following. The paperboard is rolling at a predetermined speed. A polymer film is formed and extruded onto a surface of the paperboard and both of those are extruded by a cooling roller and a pressing roller for attaching. After that, the polymer layer is processed by a corona treatment. In the same way, the polymer film is extruded onto another surface of the paperboard and is extruded by the cooling roller and the pressing roller for attaching again. A corona process is processed to the second surface too.

The above two patents both disclose that the formed polymer is extruded onto the paperboard and the corona treatment is performed after the extrusion of the cooling roller and the pressing roller. However, the defect of the prior art is that the biodegradable polymer is not so adhesive to the paperboard so that the attachment between the paperboard and the polymer is not good and gas bubbles can remain inside. Before the polymer is attached to the paperboard, the temperature is lower than the fusion point so that the polymer is formed and can not permeate into the fiber of the paperboard. After the polymer is attached to the paperboard, an extrusion by a cooling roller and a pressing roller is applied to the paperboard so that the paper and the polymer will not have a good attachment. Also, the thickness of the paperboard is not uniform because of the bubbles between the paperboard and the polymer film. The above defects need to be solved.

### SUMMARY OF THE PRESENT INVENTION

Accordingly, the primary object of the present invention is to provide a method for manufacturing a biodegradable paperboard. That is, to smear a biodegradable film onto a surface of a paperboard. The biodegradable film is heated up, liquefied and extruded by a laminating machine with the biodegradable material such as polyethylene (PET), Polylactic Acid (PLA), or corn starch. The paperboard and the biodegradable film are extruded by a double metal roller set so that the biodegradable film is permeated into the fiber of the paperboard before it is completely dried by the pressing of the roller set. Thus, the attachment between the paperboard and the biodegradable film is strong and secure. The paperboard is further formed by a cooling roller set and rolled up as a paper roll for the further cutting and hot pressing processes to produce various environment-friendly paper containers for food.

The above double metal roller set can be assembled by iron rollers and heaters are added inside the rollers so that the double metal roller set can maintain a constant temperature and the biodegradable film is kept above the fusion point to avoid a crystallization.

### BRIEF DESCRIPTION OF THE DRAWINGS

FIG. 1 is a schematic view showing the manufacturing process in the preferred embodiment of the present invention.

FIG. 2 is a perspective view showing the product according to the present invention.

FIG. 3 is a partial cross section view showing the product according to the preferred embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

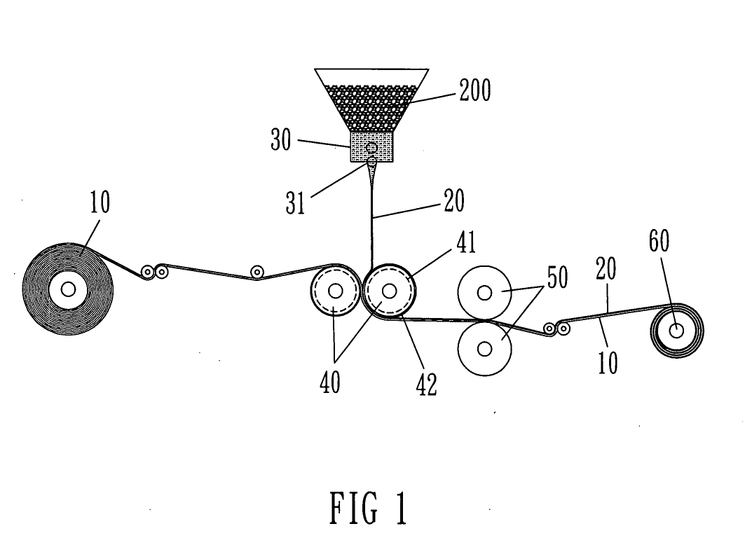

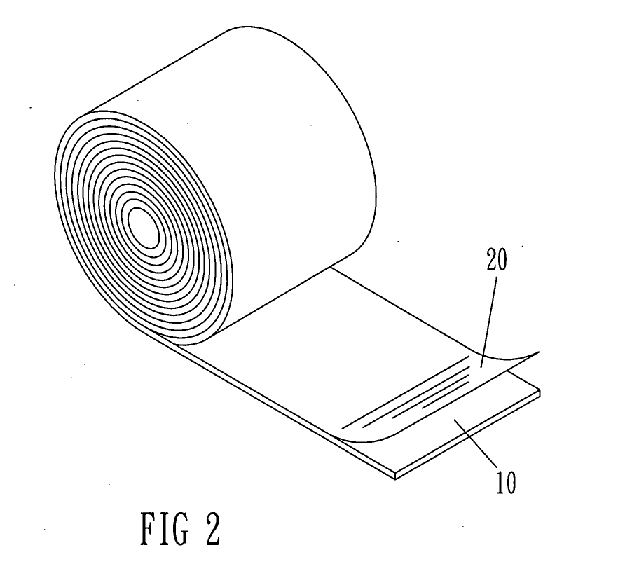

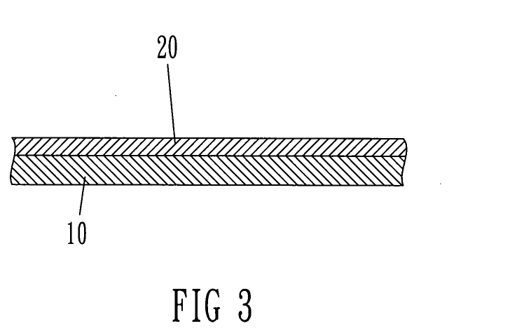

Firstly, with reference to FIGS. 1 to 3, a method for manufacturing a biodegradable paperboard according to the present invention is described in the following:

a. In order to have a good attachment between the paperboard 10 and the biodegradable film 20, a paperboard 10 from the Paper roll is processed by a preheating process and a corona treatment which neutralizes the static electricity on the surface of the paperboard.

b. A granular biodegradable material selected from polyethylene (PET), Polylactic Acid (PLA), or corn starch is liquefied by heating up and stirring through an extruder of a laminating machine. A biodegradable film 20 is continuously extruded out from an outlet 31 of the laminating machine 30.

c. A double metal roller set 40 which includes two rollers is arranged below the outlet 31 of the laminating machine 30. The paperboard 10 being deionized is guided to pass through the gap between the rollers of the double metal roller set 40 so that the biodegradable film 20 is uniformly smeared onto the surface of the paperboard 10. Before the biodegradable film 20 dries, the biodegradable film 20 permeates the fibers of the paperboard and is attached to the paperboard 10 by the strong extrusion of the double metal roller set 40. Therefore, the paperboard 10 and the biodegradable film 20 will have the best attachment effect. To keep the biodegradable film 20 higher than the fusion point while being extruded, a constant temperature heating device 41 is installed inside the double metal roller set 40 according to the present invention. The constant temperature heating device 41 can be one of an electric heater, a hot water cycle piping system, or other equivalent constant temperature devices. Moreover, the gap of the metal rollers is adjustable. A contamination proof layer 42 is formed on the double metal roller set 40, the contamination proof layer 42 can be selected by a Teflon layer. An additional remark, the double metal roller set 40 of the embodiment of the present invention is made of iron or stainless steel. With the well hardness and the low malleability of the double metal roller set 40, an expected attachment effect is provided during the extrusion of the paperboard 10 and the biodegradable film 20.

d. The paperboard with the biodegradable film 20 is extruded again by a cooling roller set 50 to make sure the biodegradable film 20 is cooled. After the last forming process of the paperboard 10 with the biodegradable film 20 is done, the finished paperboard is rolled up by a roller 60 so as to perform the further cutting process, hot press forming process to produce various environment-friendly paper containers for food.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing a biodegradable paperboard, comprising the steps of:
a. neutralizing the static electricity on the surface of a paperboard 10 after the paperboard 10 being preheating;
b. heating up and liquefying a biodegradable material by a laminating machine and continuously extruding out the biodegradable film from an outlet of the laminating machine;
c. passing the paperboard through the gap of a double metal roller set below the outlet of the laminating machine so that the biodegradable film being uniformly smeared onto the surface of the paperboard and permeating into the fiber of the paperboard by extrusion of the double metal roller set;
d. forming the paperboard with the biodegradable film by the extrusion of a cooling roller set so as to perform further cutting process and hot press forming process to produce various environment-friendly paper containers for food.

2. The method for manufacturing a biodegradable paperboard as claimed in claim 1, wherein the double metal roller set has a constant temperature heating device installed therein.

3. The method for manufacturing a biodegradable paperboard as claimed in claim 1, wherein a contamination proof layer is formed on the surfaces of the metal rollers of the double metal roller set.

4. The method for manufacturing a biodegradable paperboard as claimed in claim 3, wherein the contamination proof layer is a Teflon contamination proof layer.

5. The method for manufacturing a biodegradable paperboard as claimed in claim 1, wherein the biodegradable material is one of polyethylene (PET), Polylactic Acid (PLA), or corn starch.
